(19) United States
(12) Patent Application Publication
(10) Pub. No.: US 2003/0096879 A1
(43) Pub. Date: May 22, 2003

(54) Gels of hyaluronic acid cross-linked with bi-functional l-aminoacids or l-aminoesters or mixtures thereof

(76) Inventors: Luigi Fratini, Firenze (IT); Maurizio Meldoli, Cesena (IT)

Correspondence Address: Abelman Frayne & Schwab, 150 East 42nd Street, New York, NY, 10017-5612, US

(21) Appl. No.: 10/203,506

(22) PCT Filed: Feb. 6, 2001
(86) PCT No.: PCT/EP01/01239

(30) Foreign Application Priority Data
Feb. 8, 2000 (IT) FI2000A000020

(51) Int. Cl. C09K 3/00

(52) U.S. Cl. 516/98

(57) ABSTRACT

Gels consisting of hyaluronic acid cross-linked with bi-functional L-aminoacids or L-aminoesters or mixtures thereof are described.

### FIELD OF THE INVENTION

The present invention refers to gels insoluble in water consisting of hyaluronic acid cross-linked with bi-functional L-aminoacids, L-aminoesters or their mixtures, to a process for their preparation and to their use in the pharmaceutical, cosmetic and medical fields.

### STATE OF THE ART

Hyaluronic acid is a mucopolysaccharide consisting of alternated units of D-glucuronic acid and N-acetyl-glucosamine, bound together by β1-3 and β1-4 bindings (1).

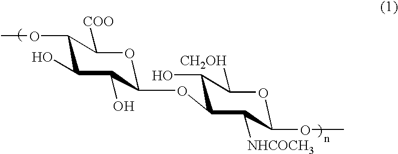

Hyaluronic acid is found in nature in the synovial liquid of articular joints, in the vitreous humor of eyes, in the umbilical cordon and in the connective tissues; can be obtained by extraction from animal tissues like cockscombs or umbilical cordons, or can be recovered from the fermenting broths of specific Streptococci. The development of biotechnology allowed the optimisation and improvement of the last described method of production of hyaluronic acid (recovering from fermentation broths) and is nowadays the one considered the most simple and rewarding.

The essential role played by hyaluronic acid in the human body is due to the peculiar viscoelastic, lubricant and hydrophilic characteristics of its aqueous solutions.

The applications of hyaluronic acid in various fields, surgical, pharmacological or more generally biomedical, are widely described in literature, see for example:

Balazs et al. “Hyaluronan Biomaterials: Medical Applications”, Handbook of Biomaterials and Applications, ed. DL Wise et al., 1995, 2719-2741; U.S. Pat. No. - 5,559,104, 1996; Pape, Balazs, Ophthalmology, 87, No. 7, 1980; Iwata, Clin. Orthop., 289, 285-291; 1993; U.S. Pat. No. - 5,128,326; U.S. Pat. No. - 4,500,676; U.S. Pat. No. - 5,840,046;

U.S. Pat. No. - 5,795, 584; U.S. Pat. No. - 6,010,692; U.S. Pat. No. - 5,658,331.

Moreover a wide literature describes various compounds obtained by cross-linking hyaluronic acid with, for example, formaldehyde (Balazs, U.S. Pat. No. 4,713,448, 1987), divinyl sulphone (Balazs, U.S. Pat. No. 4,582,865, 1986), aziridine, alcohols (Della Valle, U.S. Pat. No. 4,851,521, 1989) and mono-functional aminoacids (Hamilton, U.S. Pat. No. 4,937,270, 1990).

As it can be seen from the above said, hyaluronic acid can be chemically modified in order to modify its characteristics and obtain products suitable for various applications.

It is therefore evident the importance of making available new compounds capable of widening and improving the use of hyaluronic acid in the known or in new fields.

### DETAILED DESCRIPTION OF THE INVENTION

The present invention refers to gels insoluble in water prepared by cross-linking hyaluronic acid with bi-functional L-aminoacids or L-aminoesters or their mixtures. The introduction of little biocompatible molecules as the α L-aminoacids in the hyaluronic acid chains, under particular reaction conditions, allowed the preparation of gels having the characteristic uncoloured and transparent appearance and high biocompatible and viscoelastic properties.

The products according to the present invention can be prepared in an organic solvent such as dimethylformamide (DMF) and dimethylsulphoxide (DMSO) or in water in the presence of carbodiimide according to a known process (see for example Tomihata, J. Biomed. Mater. Res., 1997, 37(2), 243-251; Danishefsky, Carbohydrate Res., 1971, 16, 199-205).

This reaction is carried out in two subsequent steps: the first step concerns the activation of hyaluronic acid, and the second one the formation of bonds between hyaluronic acid and the cross-linking agent.

During the activation step the carboxylic groups of hyaluronic acid sodium salt react with an activating compound, thus forming a novel chemical product having an increased electrophilic character of the carboxylic groups.

In the following step a cross-linking agent is added, this agent comprises two nucleophilic functions able to bind the activated carboxylic groups, making thus cross-links, i.e. bridging bonds between the hyaluronic acid molecules. Moreover, the good exiting properties of the activating agent favour the reaction.

The present activating agents are those commonly used in the literature to this aim, and in particular the water soluble carbodiimides; according to the present invention the N-3-dimethylamino-propylethylcarbodiimide hydrochloride is particularly preferred.

According to the present invention the cross-linking agents are bi-functional α L-aminoacids i.e. having a second functional group besides the aminoacidic group - or L-aminoesters or mixtures thereof. Particularly preferred are L-lysine, L-serine, L-lysine ethylester di-hydrochloride and L-serine methylester hydrochloride or mixtures thereof.

The use of aminoesters instead of aminoacids allows the protection of the carboxylic functions of aminoacids in relation to a possible activation and involvement in secondary reactions.

The whole preparation process is carried out as described herein after. The reaction is carried out by using a glass reactor equipped with a stirring system and a temperature controller. The hyaluronic acid sodium salt commercially available is dissolved in water in a concentration comprised between 0.5 and 2.5% (w/w) following to the characteristics in the final product. For example, in order to yield compact and thick gels high concentrations are needed, for example concentrations of 2-2.5%; whereas at concentrations comprised between 0.5 and 1 % fluid gels are obtainable.

The temperature is an essential condition to obtain the products of the invention, and it must be comprised between 0° C. and 25° C., and preferably between 0° C. and 10° C.

The reaction mixture is then acidified by adding a diluted acid, such as hydrochoric acid 0.5-1 M, until a pH value comprised between 3 and 6, preferably 5, is reached. An activating agent able to activate the carboxylic groups of hyaluronic acid toward cross-linking, is then added. The activating agent is preferably added in a quantity comprised between 0.2 and 2 equivalents per equivalent of monomeric unit in the starting hyaluronic acid.

In succession the cross-linking agent is added, in a quantity preferably comprised between 0.1 and 2 equivalents per equivalent of monomeric unit of the starting hyaluronic acid.

Following to the additions above, the reaction mixture is maintained under stirring for a time comprised between 5 minutes and 48 hours, and preferably between 15 minutes and 5 hours.

Once the reaction is completed, a volume of the solution of NaCl 1 M is added, the mixture is maintained under stirring for some minutes, then a purification is carried out according to known methods, such as dialysis and/or precipitation with organic solvent and/or under vacuum evaporation and/or freeze drying.

The reaction may be carried out in an organic solvent, such as DMSO or DMF, or in a mixture water/organic solvent in different ratios; the use of water as the reaction solvent is certainly preferred but, sometimes, it is necessary to use organic solvents for specific applications of the present products. So the reaction is carried out, by adding in succession a solution in the organic solvent of the activating agent, preferably 2-chloro-1-methylpyridine iodide, and a suspension of the cross-linking aminoacid, to a solution of the hyaluronic acid salt of tetrabutylammonium in the organic solvent or in a mixture of the organic solvent and water, in the presence of triethylamine and under stirring, maintaining the temperature lower than 5C.

The so obtained mixture is maintained under stirring for a time comprised between 5 minutes and 48 hours, and preferably between 15 minutes and 5 hours. The product is then recovered and purified according to the above mentioned methods. The solid product may be dissolved again in water or in physiologic solution, in different concentrations so to obtain viscous solutions, gels, thin films, etc. In the following examples both preparation procedures are illustrated.

The ratios hyaluronic acid/activating agent/cross-linking agent selected for the synthesis depend on the desired cross-linking degree and the viscoelastic characteristics.

The characteristics of the final product are affected by the type of starting hyaluronic acid. As a matter of fact, it is evident that, under the same conditions, a hyaluronic acid having higher molecular weight produces a more viscous and compact gel with respect to that obtainable starting from a hyaluronic acid having a lower molecular weight.

According to a preferred embodiment of the invention, a hyaluronic acid having a molecular weight comprised between 100,000 and 2,000,000 is used, and the final products obtained have a molecular weight comprised between 200,000 and 2,500,000.

The final products show a cross-linking degree comprised between 10 and 40% and an intrinsic viscosity comprised between 300 and 1,500 mg/l.

The activating agent is preferably a carbodiimide soluble in water, in particular the N-3-dimethylamino-propylethylcarbodiimide hydrochloride.

The cross-linking agent is preferably L-lysine or L-serine or esters thereof, preferably ethyl or methyl esters.

The invention will be better understood in view of the following examples.

### EXAMPLE 1

1 g of hyaluronic acid sodium salt (2.5 mmol) are dissolved in 80 ml of demineralized water. The temperature is maintained at 20° C. by means of a thermostatic bath and the pH value is brought to 5 by addition of HCl 0.75 M. 0.58 g (1.2 eq) of N-3-dimethylamino-propylethylcarbodiimide hydrochloride and 0.44 g (1.2 eq) of L-lysine are added.

After 2 hours 80 ml of NaCl solution 1 M are added, and the solution is dialysed with distilled water; the product is precipitated with acetone, dissolved again in water and finally freeze-dried.

### Example 2

1 g of hyaluronic acid sodium salt (2.5 mmol) are dissolved in 80 ml of demineralized water. The temperature is maintained at 20° C. by means of a thermostatic bath and the pH value is brought to 5 by addition of HCI 0.75 M. 0.58 g (1.2 eq) of N-3-dimethylamino-propylethylcarbodiimide hydrochloride and 0.74 g (1.2 eq) of L-lysine ethyl ester di-hydrochloride are added.

After 1 hour 80 ml of NaCl solution 1M are added, and the solution is dialysed three times, and finally freeze-dried.

### Example 3

1 g of hyaluronic acid sodium salt (2.5 mmol) are dissolved in 80 ml of demineralized water. The temperature is maintained at 4° C. by means of a thermostatic bath and the pH value is brought to 5 by addition of HCl 0.75 M.

0.48 g (1.0 eq) of N-3-dimethylamino-propylethylcarbodiimide hydrochloride and 0.62 g (1.0 eq) of L-lysine ethyl ester di-hydrochloride are added.

After 3 hour 80 ml of NaCl solution 1 M are added, and the solution is dialysed three times, and finally freeze-dried.

The ¹H-NMR analysis on the so obtained product has shown the following characteristic signals (solvent D₂O):

1.2 ppm (t, 3H, J=10.6 Hz, CH₃—CH₂CH₂O—Lys)

1.4 ppm (m, 2H, CH₂ δ Lys)

1.6 ppm (m, 2H, CH₂ β Lys)

1.7-1.9 ppm (m, 2H, CH₂ β Lys)

1.9-2.0 ppm (m, 3H, CH₃—CONH hyaluronic acid)

2.9 ppm (t, 2H, J=11.2 Hz, CH₂ ε Lys)

3.0-3.9 ppm (m, CHOH hyaluronic acid)

4.0 ppm (t, 1H, J=9.6 Hz, CH α Lys)

4.2 ppm (q, 2H, J=10.6 Hz, CH₃—CH₂O—Lys)

### Example 4

1.0 g of hyaluronic acid sodium salt (2.5 mmol) are dissolved in 80 ml of demineralized water. The temperature is maintained at 4° C. by means of a thermostatic bath and the pH value is brought to 5 by addition of HCl 0.75 M.

0.24 g (0.5 eq) of N-3-dimethylamino-propylethylcarbodiimide hydrochloride and 0.62 g (1.0 eq) of L-lysine ethyl ester di-hydrochloride are added.

After 3 hours 80 ml of NaCl solution 1 M are added, and the solution is dialysed three times, and finally freeze-dried.

### Example 5

1.0 g of hyaluronic acid sodium salt (2.5 mmol) are dissolved in 80 ml of demineralized water. The temperature is maintained at 4° C. by means of a thermostatic bath and the pH value is brought to 5 by addition of HCl 0.75 M.

0.24 g (0.5 eq) of N-3-dimethylamino-propylethylcarbodiimide hydrochloride and 0.62 g (1.0 eq) of L-lysine ethyl ester di-hydrochloride are added. After 20 minutes 80 ml of NaCl solution 1 M are added, and the solution is dialysed three times, and finally freeze-dried.

### Exaple 6

1.0 g of hyaluronic acid sodium salt (2.5 mmol) are dissolved in 80 ml of demineralized water. The temperature is maintained at 20° C. by means of a thermostatic bath and the pH value is brought to 5 by addition of HCl 0.75 M.

0.58 g (1.2 eq) of N-3-dimethylamino-propylethylcarbodiimide hydrochloride and 0.47 g (1.2 eq) of L-serine methyl ester hydrochloride are added.

After 3 hours 80 ml of NaCl solution 1 M are added, and the solution is dialysed with distilled water; the product is then precipitated with acetone, dissolved again in water, and finally freeze-dried.

### Example 7

1.0 g of hyaluronic acid sodium salt (2.5 mmol) are dissolved in 80 ml of demineralized water. The temperature is maintained at 5° C. by means of a thermostatic bath and the pH value is brought to 5 by addition of HCl 0.75 M.

0.47 g (1.0 eq) of N-3-diethylamino-propylethylcarbodiimide hydrochloride and 0.19 g (0.5 eq) of L-serine methyl ester hydrochloride are added.

After 3 hours 80 ml of NaCl solution 1 M are added, and the solution is dialysed three times, and finally freeze-dried.

### Example 8

1.0 g of hyaluronic acid sodium salt (2.5 mmol) are dissolved in 80 ml of demineralized water. The temperature is maintained at 0° C. by means of a thermostatic bath and the pH value is brought to 5 by addition of HCl 0.75 M.

0.24 g (0.5 eq) of N-3-diethylamino-propylethylcarbodiimide hydrochloride and 0.19 g (0.5 eq) of L-serine methyl ester di-hydrochloride are added.

After 15 minutes 80 ml of NaCl solution 1M are added, and the solution is dialysed three times, and finally freeze-dried.

### Example 9

0.5 g of hyaluronic acid tetrabutylammonium salt are dissolved in 45 ml of DMF, under stirring and at the temperature of 5° C.

Once the salt is completely dissolved, 200 μl of triethylamine, 0.20 9 of 2-chloro-1-methyl-pyridine iodide and 0.5 g of L-lysine are added.

The resulting gel is filtered, washed with water, and freeze-dried.

### Example 10

0.3 g of hyaluronic acid tetrabutylammonium salt are dissolved in 30 ml of DMF, under stirring and at the temperature of 5° C.

Once the salt is completely dissolved, 120 ml of triethylamine, 0.12 g of 2-chloro-1-methyl-pyridine iodide and 0.21 g of L-serine are added.

The resulting gel is filtered, washed with water, and freeze-dried.

Analogously, gels of hyaluronic acid are prepared using as the cross-linking agent mixtures of L-lysine and L-serine, L-lysine ethylester di-hydrochloride and L-serine methylester hydrochloride or mixtures amnoacid/aminoacid esterified, obtaining then products having characteristics analogous to those of the products described above.

1. A water soluble gel consisting of hyaluronic acid cross-linked with bi-functional cross-linking agents.

2. The gel according to claim 1, wherein the said bi-functional cross-linking agents are L-aminoacids, L-aminoesters or mixtures thereof.

3. The gel according to claim 2, wherein the said bi-functional cross-linking agents are L-lysine, L-serine, L-lysine ethylester di-hydrochloride, L-serine methylester hydrochloride or mixtures thereof.

4. The gel according to claims 1-3, wherein the hyaluronic acid has a molecular weight comprised between 100,000 and 2,500,000 and an intrinsic viscosity comprised between 300 and 1,500 mug.

5. Process for the preparation of the gel as described in claim 1, wherein:
a) the hyaluronic acid sodium salt is dissolved in water under stirring and the reaction mixture is then acidified by adding a diluted acid, until a pH value comprised between 3 and 6 is reached;
b) an activating agent and then a cross-linking agent are added to the solution under stirring;
c) once the reaction is completed, to the resulting mixture a solution of NaCl 1 M is added under stirring, then the separation and purification procedure of the so obtained product is carried out.

6. The process according to claim 5, wherein the temperature is comprised between 0° C. and 25° C.

7. The process according to claim 6, wherein the temperature is comprised between 0° C. and 10° C.

8. The process according to claims 5-7, wherein the activating agent is a carbodiimide soluble in water.

9. The process according to claim 8, wherein the activating agent is N-3-dimethylamino-propylethylcarbodiimide hydrochloride.

10. The process according to claim 5-9, wherein the cross-linking agent is an aminoacid as reported in claims 2 and 3.

11. The process according to claims 5-10, wherein the hyaluronic acid solution in water has a concentration comprised between 0.5 and 2.5% (w/w), the activating agent is added in a quantity comprised between 0.2 and 2 equivalents per equivalent of monomeric unit of hyaluronic acid, and the cross-linking agent is added in a quantity comprised between 0.1 and 2 equivalents per equivalent of monomeric unit of hyaluronic acid.

12. The process according to claim 11, wherein the time of reaction is comprised between 5 minutes and 48 hours.

13. The process according to claim 12, wherein the time of reaction is comprised between 15 minutes and 5 hours.

14. Use of the gel as described in claims 1-4 in surgery, in the pharmacological field or, in general, in the biomedical field.
